(19) United States
(12) Patent Application Publication
(10) Pub. No.: US 2010/0253757 A1
(43) Pub. Date: Oct. 7, 2010

(54) KEYBOARD, PRINTING METHOD OF PATTERN ON KEY CAP, AND PRINTING METHOD OF PATTERN ON KEYBOARD

(76) Inventors: Hung-Ming TSENG, Taichung City (TW); Chen-Sheng Tu, Sanchong City (TW); Tung-Lung Lin, Taoyuan City (TW)

Correspondence Address: NORTH AMERICA INTELLECTUAL PROPERTY CORPORATION, P.O. BOX 506, MERRIFIELD, VA, 22116, US

(21) Appl. No.: 12/752,670

(22) Filed: Apr. 1, 2010

(30) Foreign Application Priority Data
Apr. 3, 2009 (TW) 098111259

(51) Int. Cl. B41J 2/01; B41J 5/00

(52) U.S. Cl. 347/102; 400/490

(57) ABSTRACT

A keyboard which includes a plurality of key caps is provided. Each of the key caps includes a surface respectively and the surfaces of the key caps are coplanar substantially. Therein a pattern which includes a plurality of ink dots is formed on each surface of the key caps. The pattern formed by the ink dots could be a symbol, a character, a graph, or a combination thereof and several patterns could form a combination pattern. Additionally, the patterns could be covered with a protection layer.

### BACKGROUND OF THE INVENTION

1. Field of the Invention

The invention relates to a keyboard, a printing method of pattern on a key cap, and a printing method of pattern on a keyboard, and more particularly, to a keyboard with key cap patterns formed by spraying ink dots via a nozzle and the printing method thereof.

2. Description of the Prior Art

In order to make users easy to use a keyboard to input various commands or information, the corresponding symbol or text (e.g., letters A, B, or numbers) is labeled on each key on the keyboard. And, these numbers or symbols are mainly printed on the key cap of the key through a method of adhering ticker, screen printing, laser engraving, or transferring printing.

As to the screen printing method, before printing the symbols and texts on the key cap, the screen must be used at first, and the ink is printed on the key cap through holes of the screen. The color of the symbol on the key cap is determined by the color of the ink. And, in the laser engraving method, the laser is used to engrave on the surface of the key cap, a part of the surface of the key cap emitted by the laser will be vaporized and original color of the material will be shown. As to the transferring printing method, a photo plate manufacturing method is used at first to make the steel plate to be a concave plate, and then the pattern needed to be printed will be reprinted on the key cap through a special made silicone print head.

No matter what method mentioned above is used to print the text or symbol on the key, the text or symbol always has one color only. If other colors are needed to be added, other process must be used. For example, when the screen printing technology is used to print “Caps Lock”, if the user wants to make the color of “Caps” different from the color of “Lock” (e.g., one is red, the other is black), two screens must be labeled “Caps” and “Lock”. Practically, one screen and one ink are used to print over one of the vocabularies at first; the other screen and the other color ink are then used to print other vocabulary after the ink is dried. Therefore, two processes must be used to achieve the color changing effect. It is quite difficult to use the laser engraving or transferring printing method to add the colors of the symbols on the key to make the symbol or text to have many colors or show gradient color effect. Therefore, it is more difficult to change the style of the symbol or the text. Once the user wants to change the style of the symbol or text through the screen printing method or transferring printing method, the screen plate must be reproduced, so that a lot of production time and cost will be spent.

### SUMMARY OF THE INVENTION

Therefore, the invention discloses a keyboard, a printing method of pattern on a key cap, and a printing method of pattern on a keyboard to solve the above-mentioned problems.

A scope of the invention is to provide a keyboard. The keyboard of the invention includes a plurality of key caps. Each key cap has a surface respectively, and the surfaces of the key caps are actually on the same plane. Additionally, a pattern including a plurality of ink dots is formed on the surface of the key cap, and the plurality of ink dots can be dots with different colors. A nozzle is used to form the pattern on the keyboard. The pattern formed by the plurality of ink dots can be symbol, text, logo, or their combination, and even a combination pattern can be formed by several patterns. Furthermore, a protection layer can be formed on each pattern to enhance the wearing resistance of the patterns.

Another scope of the invention is to provide a key cap pattern printing method. The key cap pattern printing method of the invention includes the following steps. At first, a plurality of ink dots is sprayed on the surface of the key cap to form a pattern. Then, the pattern on the surface of the key cap will be dried. And, the method of spraying ink dots on the surface of the key cap is to use a nozzle to spray the plurality of ink dots on the surface of the key cap. The plurality of ink dots can have different colors.

Another scope of the invention is to provide a keyboard pattern printing method. The keyboard pattern printing method of the invention includes the following steps. At first, a keyboard is provided. The keyboard has a plurality of key caps. Each keycap has a surface, and the surfaces of the plurality of key caps are actually on the same plane. Then, a plurality of ink dots is sprayed on the surface of the key caps to form a plurality of patterns. Afterward, the plurality of patterns on the surfaces of the key caps is dried. And, the method of spraying ink dots on the surfaces of the key caps is also to use a nozzle to spray the plurality of ink dots on the surfaces of the key caps.

Above all, as to the keyboard, the key cap pattern printing method, and the keyboard pattern printing method of the invention, a plurality of ink dots with different colors can be used to form the pattern on the surface of the key cap, and the pattern formed can have various colors. In addition, the plurality of ink dots can be combined to be symbols, texts, or logos with different types, so that the types of the patterns formed will be not limited and the pattern effect of various colors and types can be achieved without repeated processes. Compared to the prior art, the number of the color of the pattern of the conventional key cap is only one or two and the pattern on the surface of the key cap has fixed type. However, the pattern on the key cap in the invention can select different colors, logos, or symbols according to user's requirement, and the key cap pattern printing method and the keyboard pattern printing method of the invention can save the time of printing the patterns.

The objective of the present invention will no doubt become obvious to those of ordinary skill in the art after reading the following detailed description of the preferred embodiment, which is illustrated in the various figures and drawings.

### BRIEF DESCRIPTION OF THE APPENDED DRAWINGS

FIG. 1A shows a keyboard of an embodiment in the invention.

FIG. 1B shows an enlarged diagram of the pattern shown in FIG. 1A.

FIG. 1C shows the pattern shown in FIG. 1B having various colors.

FIG. 1D shows the colors of the pattern shown in FIG. 1B are gradient.

FIG. 1E shows a keyboard of another embodiment in the invention.

FIG. 1F shows a keyboard of another embodiment in the invention.

FIG. 2 shows a flowchart of printing the key cap pattern in the invention.

FIG. 3 shows a scheme diagram of the spraying apparatus of an embodiment in the invention.

FIG. 4 shows a flowchart of printing the keyboard pattern in the invention.

### DETAILED DESCRIPTION OF THE INVENTION

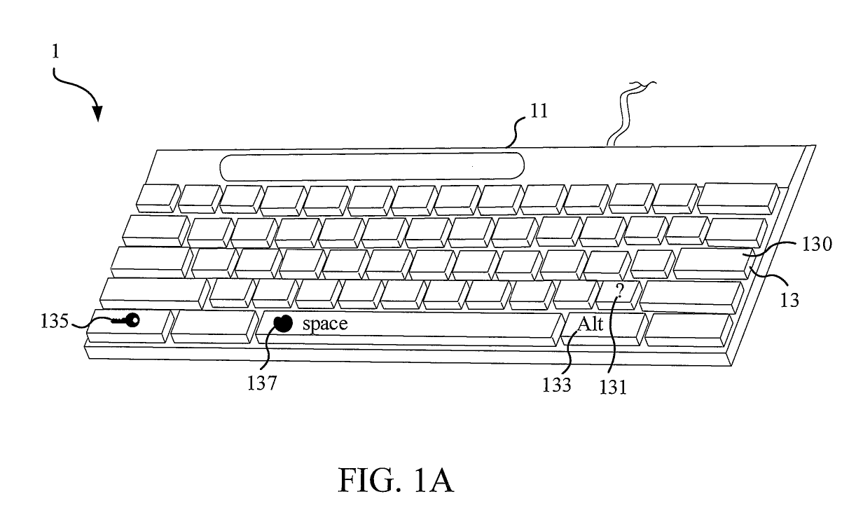

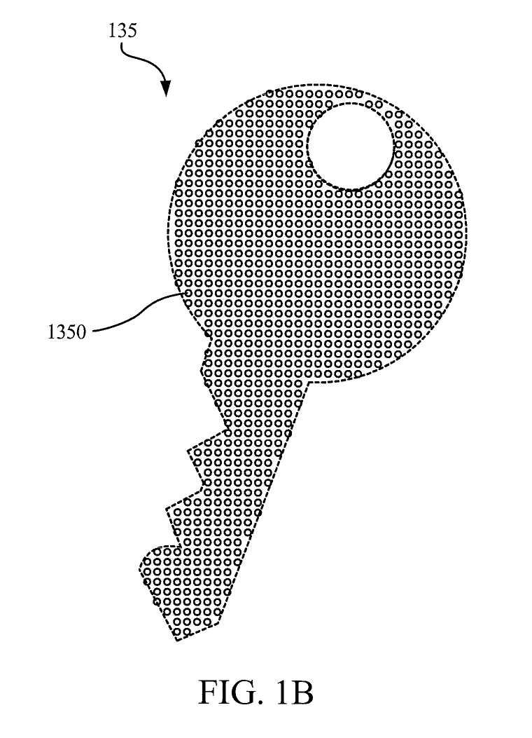

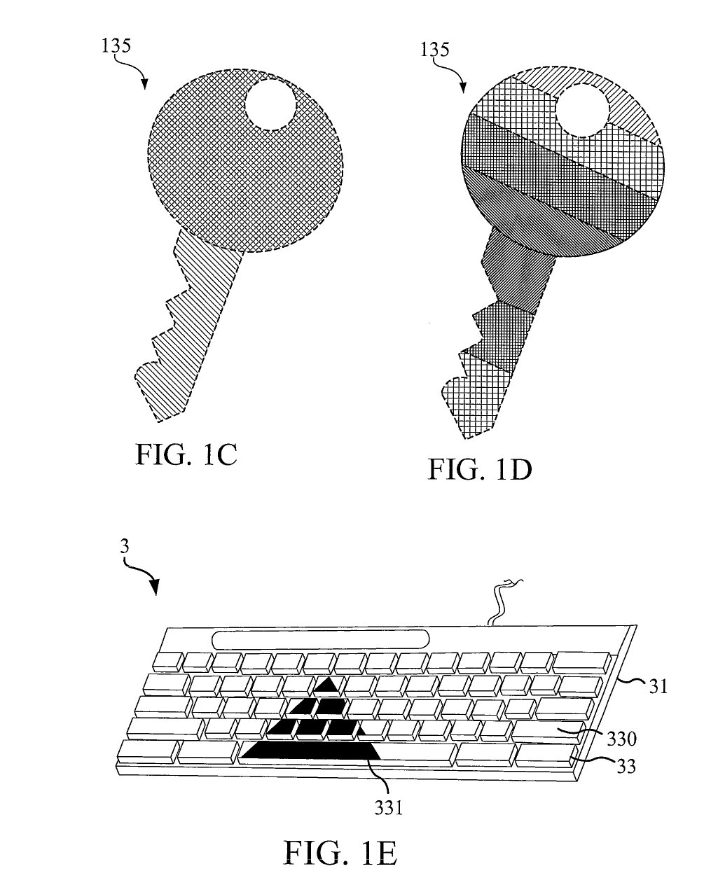

A scope of the invention is to provide a keyboard. Please refer to FIG. 1A. FIG. 1A shows a keyboard 1 of an embodiment in the invention. As shown in FIG. 1A, the keyboard 1 of the invention includes a housing 11 and a plurality of key caps 13 (only one key cap 13 is labeled). The key cap 13 is a part of the key, the user inputs different information into the computer apparatus via the key. The key is mainly composed of a supporting structure (not shown in the figure) and the key cap 13 disposed above the supporting structure. In order to make the user easy to press the key, a part of key cap 13 will be exposed out of the housing. Each key cap 13 has a surface 130 respectively (only one key cap surface is labeled). The user can press the key via the surface 130, and the user can use the various symbols or texts on the surface 130 of the key cap 13 to recognize the key cap 13.

As shown in FIG. 1A, the surfaces of the plurality of key caps 13 of the keyboard 1 are actually on the same plane, and plan degree of the surface 130 of the key cap 13 is smaller than 0.7 mm. In addition, the patterns 131, 133, 135, and 137 including a plurality of ink dots are formed on the surface 130 of the key cap 13. In this embodiment, the radius of the plurality of ink dots is about 20 nm˜200 nm, therefore, the ink dots are represented by the contours of filling the patterns 131, 133, 135, and 137 in FIG. 1A. And, the patterns 131, 133, 135, and 137 formed by the plurality of ink dots can be symbols, texts, logos, or their combination. Taking FIG. 1A for example, the pattern 131 is the symbol “?”, the pattern 133 is the text “Alt”, the pattern 135 is the logo of a key, and the pattern 137 is the combination of the heart logo and the text “space”. It should be noticed that the types and the number of the patterns 131, 133, 135, and 137 are not limited by the embodiment, and for the sake of simplification, only the patterns 131, 133, 135, and 137 are shown in this embodiment.

Please refer to FIG. 1B. FIG. 1B shows the enlarged diagram of the pattern 135 shown in FIG. 1A. From FIG. 1B, it can be found that the key logo 135 on the key cap 13 is actually composed of a plurality of ink dots 1350, and the plurality of ink dots 1350 are separated to each other. It should be noticed that in FIG. 1B, the ink dots 1350 is shown by enlarged circles, so that in real proportion, the proportion of the ink dots 1350 will be smaller; in addition, the dotted line is used to represent the contour of the key logo 135 in FIG. 1B.

In the same way, the patterns 131, 133, and 137 are also formed by using the plurality of ink dots 1350. The ink dot 1350 can be a UV curing ink, an alcohol ink, an oil-based ink, or other inks capable of being sprayed or adhered on the surface 130. If the ink dot 1350 is the UV curing ink, under the radiation of the UV light, the monomers of the connecting material of the ink can be polymerized to be a polymer by using the UV light with different wavelengths and energies to further make the ink become a film and be dried.

In addition, the plurality of ink dots can be formed via an apparatus similar to an inkjet printer, and the apparatus further includes a nozzle used for spraying ink dots (the ink dots are sprayed from the nozzle) and an ink supply system used for storing ink. The different inks with different colors stored in the ink supply system can be selected based on the requirement of pattern design and sprayed from the nozzle to form the ink dots with different colors. For example, the ink dot can be a black dot, a white dot, a red dot, a green dot, a yellow dot, or their combination. Taking the pattern 133 in FIG. 1A for example, the pattern 133 is the vocabulary “Alt”. The letter “A” can be designed as red, the letter “l” can be designed as green, and the letter “t” can be designed as blue. And, the nozzle is used to spray the red dot, the green dot, and the blue dot on the surface 130 of the key cap 13 to form “A”, “l”, and “t” respectively. Of course, because the ink dot 1350 is the smallest unit of the pattern 133, so that the above-mentioned letter “t” can include various kinds of colors.

As mentioned above, the patterns 131, 133, 135, and 137 are thinned by spraying the plurality of ink dots on the surface of the key cap 13 via the nozzle, and the ink dots with different colors can be used to foam the symbol, text, or logo. In other words, the colors on the same pattern can be also different. Please refer to FIG. 1C. FIG. 1C shows the pattern 135 shown in FIG. 1B having various colors. It should be noticed that in order to show the different color regions of the ink dot, the different color regions will be represented by different line patterns, and the contours of the different color regions will be represented by the dotted lines.

As shown in FIG. 1C, the pattern 135 is a key logo, the color of the top part of the key is black, the hole part of the key is uncolored (or white), and the other parts of the key is red. Practically, the color of the top part of the key can be the color other than black, and the color of the other parts is not limited by light grey or white. Of course, the color of the same pattern can be also the gradient color as shown in FIG. 1D. In the same way, in FIG. 1D, different line patterns represent different colors of the ink dots in different regions, and the contours of various regions are represented by the dotted lines. It should be noticed that the colors shown in the regions mentioned above can be shown by the proportion of the amount of the ink dots with different colors. In other words, the above-mentioned patterns 131, 133, 135, and 137 can be color-printed as the drawing printed on the paper.

Furthermore, in order to enrich the change of the patterns, the patterns on the plurality of key caps can be combined to form a combination pattern. Please refer to FIG. 1E. FIG. 1E shows the keyboard 3 of another embodiment in the invention. As shown in FIG. 1E, the keyboard 3 of the invention includes a housing 31 and a plurality of key cap 33. Different patterns are formed on the surface 330 (only one is labeled) of the plurality of key caps 33 respectively, and these different patterns will be combined to be a combination pattern 331, as the pyramid shown in FIG. 1E. The style of the combination pattern 331 is not limited by the pyramid, and can be designed based on the user's requirement. Please refer to FIG. 1F. FIG. 1F shows the keyboard 5 of another embodiment in the invention. As shown in FIG. 1F, the keyboard 5 of the invention includes a housing 51 and a plurality of key caps 53. Different patterns 531, 533, and 535 are formed on the surface 530 (only one is labeled) of the plurality of key caps 53 respectively. Wherein, the patterns 531 and 533 are formed on the surface of a single key cap 53. And, the pattern 535 is a star logo formed by the combination of the plurality of patterns.

Since when the user uses the keyboards 1, 3, and 5, the surfaces 130, 330, and 530 of the key caps 13, 33, and 53 will be pressed continually, as time goes by, the patterns 131, 133, 135, 137, 331, 531, 533, and 535 formed on the surfaces 130, 330, and 530 of the key caps 13, 33, and 53 will be accordingly grinded. Therefore, in order to increase the wear resistance of the patterns 131, 133, 135, 137, 331, 531, 533, and 535, a protection layer can be covered on the patterns 131, 133, 135, 137 331, 531, 533, 535 to protect the patterns 131, 133, 135, 137, 331,531, 533, and 535.

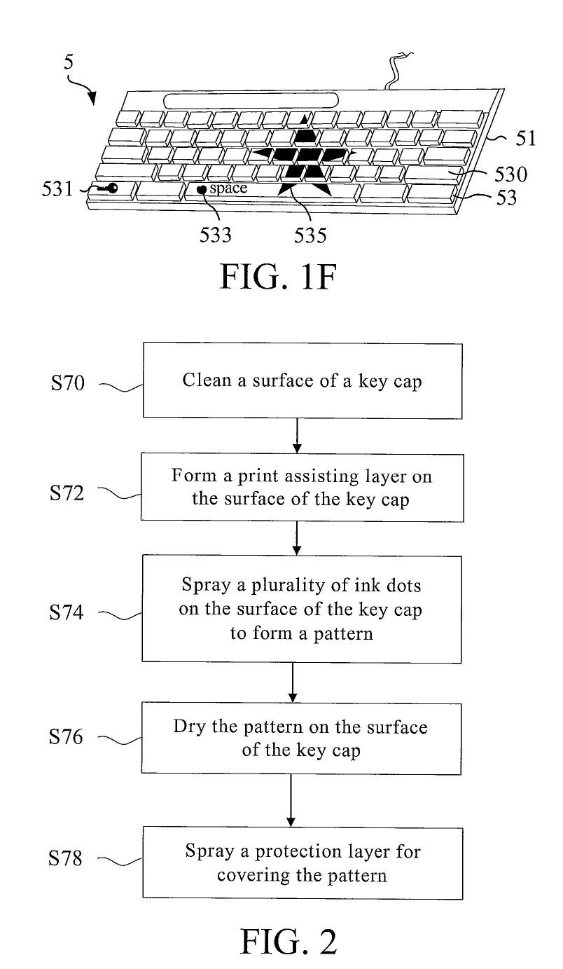

Another scope of the invention is to provide a key cap pattern printing method. The key cap pattern printing method of the invention is to use a plurality of ink dots to form a key cap pattern, and its detailed steps please refer to FIG. 2. FIG. 2 shows the flowchart of the key cap pattern printing method in the invention. As shown in FIG. 2, and taking the keyboard 1 shown in FIG. 1A and the pattern 135 shown in FIG. 1B as examples, the key cap pattern printing method of the invention includes the following steps.

S70: cleaning the surface of the key cap 13. Further, in order to prevent the residual oil gas or debris on the key cap 13 affecting the quality of the patterns 131, 133, 135, and 137. The pattern 135 will be taken as an example as follows. Before forming the pattern 135, the gas (e.g., Helium) or the solvent (e.g., Methanol) can be used to clean the surface 130 of the key cap 13, and the key cap 13 will be dried out after it is cleaned, so that the moisture or solvent will not residue on the surface 130 of the key cap 13.

S72: forming a printing assisting layer on the surface 130 of the key cap 13. Further, after cleaning the surface 130 of the key cap 13, a printing assisting agent can be sprayed on the surface 130 of the key cap 13 to form a printing assisting layer. The printing assisting layer is used to increase the adhesion between the ink dots 1350 (shown in FIG. 1B) and the surface 130. The composition of the printing assisting agent may include formaldehyde or other organic solvents.

S74: spraying the plurality of ink dots 1350 (as shown in FIG. 1B) on the surface 130 of the key cap 13 to form the pattern 135 (other patterns 131, 133, and 137 are formed in the same way). After cleaning the surface 130 of the key cap 13 and forming the printing assisting layer on the surface 130 of the key cap 13, a nozzle of a spraying apparatus is used to spray the plurality of ink dots 1350. The plurality of ink dots 1350 falls on suitable positions of the surfaces 130 of the key caps 13 separately to form the pattern 135 of the key cap 13. And, the radius of the plurality of ink dots 1350 is about 30 nm˜200 nm, and the pattern 135 formed can be a symbol, text, logo, or their combination.

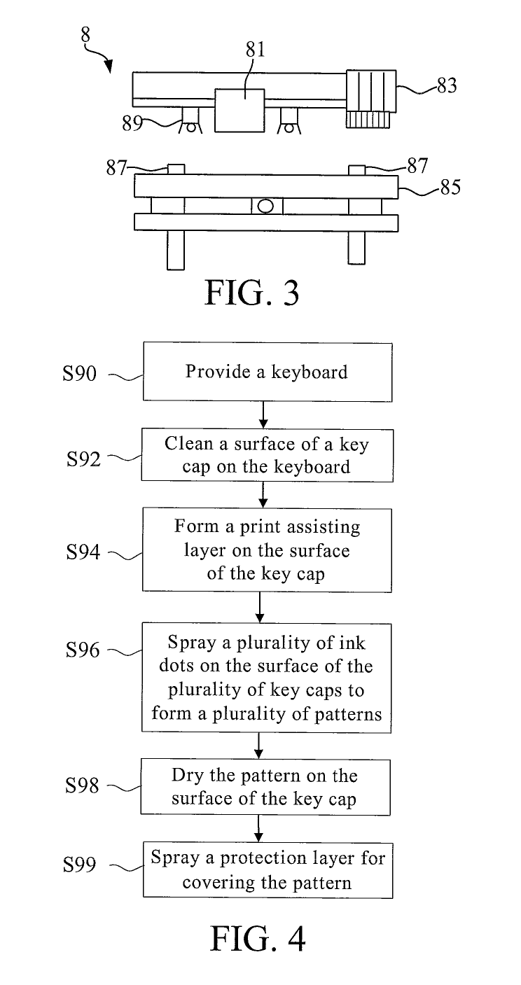

Practically, the spraying apparatus can be converted from the current inkjet printer, so that it can be suitably used to spray large object, such as the keyboard. Please refer to FIG. 3. FIG. 3 shows the spraying apparatus 8 of an embodiment in the invention. As shown in FIG. 3, the spraying apparatus 8 mainly includes a sprayer 81, an ink supply system 83, a carrier movable upward and downward 85, a positioning apparatus 87, and a drying system 89. Wherein, the sprayer 81 further includes a nozzle (not shown in the figure) used for spraying the ink dots 1350, and the ink supply system 83 is used to store inks with different colors. In fact, the user can store inks with different colors in the ink supply system 83 at first, and then the nozzle of the sprayer 81 is used to spray the ink to form the plurality of ink dots 1350. The method of spraying ink can heat the ink to make it boiling and bubbles are generated. Then, the ink will be sprayed out from the nozzle forced by the pressure of the bubble. Or a transistor will be disposed in the nozzle of the sprayer 81 to change the voltage provided to the transistor, so that the volume of the transistor will be expanded to extrude the ink to spray the ink dots 1350. In addition, since inks with different colors are stored in the ink supply system 83, so that the ink dots 1350 with different colors can be sprayed based on the color designed in the pattern 135, such as black dots, white dots, red dots, green dots, yellow dots, or their combination to form the pattern with different colors (as shown in FIG. 1C), of course, the color of the pattern 135 can be also gradient (as shown in FIG. 1D). Furthermore, in the printing method of the invention, the ink used to form the ink dots 1350 can be a DV curing ink, an alcohol ink, or an oil-based ink, and its effect as mentioned above and not mentioned again here.

S76: drying the pattern 135 on the surface 130 of the key cap 13. When the nozzle of the spraying apparatus 8 is used to spray the ink dots 1350 to form the pattern 135, a drying step should be processed to the ink dots 1350 forming the pattern 135, t this time, the drying apparatus 89 shown in FIG. 3 can be used to dry out the ink. The advantage of drying the ink is to remove the redundant moisture from the ink, and the strength of the ink fixed on the surface 130 of the key cap 13 can be also increased. If the ink used is the UV curing ink, the drying apparatus 89 will be a UV light source supply apparatus using a UV light to emit the ink dots 1350, so that the ink dots 1350 will be solidified and the pattern 135 will be dried out. IF the ink used is the alcohol ink or the oil-based ink, the drying apparatus 89 will be an infrared light source supply apparatus using an infrared light to emit the ink dots 1350, or the drying apparatus 89 can be also a hot wind supply apparatus using the hot wind to dry out the pattern 135.

S78: spraying a protection layer used for covering the pattern 135. The pattern 135 on the key cap 13 is mainly used to make the user easy to input information. As time goes by, the times of pressing the surface 130 of the key cap 13 will be increased, and the pattern 135 on the surface 130 of the key cap 13 may be worn due to the continue friction with the finger tip. Therefore, in order to increase the life of the pattern 135, after the pattern 135 is dried out, the protection layer can be further sprayed on the surface 130 of the key cap 13 to cover the pattern 135 on the surface, so that a part of the pattern 135 will not be worn to increase the completeness of the pattern 135.

In fact, the key cap pattern printing method of the invention not only can print the pattern on the surface of a single key cap, but also can print patterns on the surfaces of the key caps, even the keyboard composed of a plurality of keys are also printed. Another scope of the invention is to provide a keyboard pattern printing method. The keyboard pattern printing method uses a plurality of ink dots to form the pattern, and its detailed steps are shown in FIG. 4. FIG. 4 shows the flowchart of printing pattern on the keyboard. As shown in FIG. 4, and also refer to the keyboard 5 shown in FIG. 1F and the spraying apparatus 8 shown in FIG. 3. The keyboard pattern printing method of the invention includes the following steps.

S90: providing a keyboard 5. When the keyboard pattern printing method of the invention is used to print the keyboard patterns 531, 533, and 535, at first, a keyboard (as shown in FIG. 1A) must be provided at first. The keyboard 5 has a plurality of key caps 53, and each key cap 53 has a surface 530, and the surfaces 530 of the key caps 53 are actually on the same plane, and the plane degree of the surface 530 of the key cap 53 is smaller than 0.7 mm.

S92: cleaning the surface 530 of the key cap 53 of the keyboard. Before forming the patterns 531, 533, and 535, the surface 530 of the key cap 53 will be cleaned at first, so that the moisture or solvent will not be residuary on the surface 530 of the key cap 53. Since its cleaning method is mentioned above, it will not be mentioned again here.

S94: forming a printing assisting layer on the surface 530 of the key cap 53. A printing assisting agent is sprayed on the surface 530 of the key cap 53 of the keyboard 5 to form a printing assisting layer used for increase the adjuration between the ink dots and the surface 530.

S96: spraying the plurality of ink dots (refer to the ink dots shown in FIG. 1B) on the surface 530 of the key caps 53 to form a plurality of patterns 531, 533, and 535. When the patterns 531, 533, and 535 are printed, the keyboard 5 can be disposed on the carrier movable upward and downward 85 of the spraying apparatus 8 shown in FIG. 3, and the positioning apparatus 87 will be used to fix the keyboard 5. The nozzle (not shown in the figure) of the spraying apparatus 81 will spray the ink dots on the surface 530 of the key cap 53 of the keyboard 5. In addition, the spraying apparatus 81 will move based on the shapes of the patterns 531, 533, and 535. In fact, the structure of the spraying apparatus 8 is not limited by FIG. 3, the carrier 85 can be also designed as the 3-D movable carrier, and the nozzle for spraying ink dots can be a fixed one, the ink dots will be fallen on the suitable positions on the surface 530 of the key cap 53 by moving the carrier 85 and the nozzle relatively, to form the patterns 531, 533, and 535. Of course, the types of the patterns formed are not limited by the patterns 531, 533, and 535, they can be symbols, texts, or their combination, and patterns on the surface 530 of the key cap 53 can be combined to the a combination pattern, as the pattern 535 shown in FIG. 1F.

S98: drying out the patterns 531, 533, and 535 on the surface 530 of the key cap 53. After the patterns 531, 533, and 535 are formed on the surface 530, the drying apparatus 89 shown in FIG. 3 can be used to dry out the patterns 531, 533, and 535.

S99: spraying a protection layer used for covering the patterns 531, 533, and 535. In order to increase the life of the patterns 531, 533, and 535, after the patterns 531, 533, and 535 are dried out, the protection layer will be sprayed on the surface 530 of the key cap 53 to cover the patterns 531, 533, and 535 on the surface 530 to increase the wear resistance of the patterns 531, 533, and 535.

Above all, as to the keyboard, key cap pattern printing method, and keyboard pattern printing method of the invention, a plurality of ink dots with different colors can be used to form the pattern on the surface of the key cap, and the pattern formed can have various colors. In addition, the plurality of ink dots can be combined to be symbols, texts, or logos with different types, so that the types of the patterns formed will be not limited and the pattern effect of various colors and types can be achieved without repeated processes. Compared to the prior art, the number of the color of the pattern of the conventional key cap is only one or two and the pattern on the surface of the key cap has fixed type. However, the pattern on the key cap in the invention can select different colors, logos, or symbols according to user's requirement, and the key cap pattern printing method and the keyboard pattern printing method of the invention can save the time of printing the patterns.

Although the present invention has been illustrated and described with reference to the preferred embodiment thereof, it should be understood that it is in no way limited to the details of such embodiment but is capable of numerous modifications within the scope of the appended claims.

What is claimed is:

1. A keyboard, comprising:
a plurality of key caps, each of the plurality of key caps having a surface, the surfaces of the plurality of key caps being actually on the same plane, wherein a pattern comprising a plurality of ink dots is formed on the surface, and a nozzle is used to form the pattern on the keyboard.

2. The keyboard of claim 1, wherein the ink dot is a UV curing ink, an alcohol ink, or an oil-based ink.

3. The keyboard of claim 1, wherein the pattern comprises a symbol, a text, a logo, or their combination.

4. The keyboard of claim 1, wherein the plurality of patterns forms a combination pattern.

5. The keyboard of claim 1, wherein each of the plurality of key caps further comprises a protection layer to cover the pattern.

6. A key cap pattern printing method, comprising the steps of:
(a) spraying a plurality of ink dots on a surface of a key cap to form a pattern; and
(b) drying the pattern on the surface.

7. The key cap pattern printing method of claim 6, further comprising the step of:
forming a print assisting layer on the surface to increase the adhesion between the plurality of ink dots and the surface before the step (a).

8. The key cap pattern printing method of claim 6, wherein in step (a), a nozzle is used to spray the plurality of ink dots.

9. The key cap pattern printing method of claim 6, wherein the ink dot is a UV curing ink, an alcohol ink, or an oil-based ink.

10. The key cap pattern printing method of claim 6, wherein in step (b), a UV light or an infrared light is used to irradiate to dry the pattern, a hot wind is used to dry the pattern.

11. The key cap pattern printing method of claim 6, wherein the pattern comprises a symbol, a text, a logo, or their combination.

12. The key cap pattern printing method of claim 6, further comprising the step of:
(c) spraying a protection layer to cover the pattern.

13. A key cap pattern printing method, comprising the steps of:
(a) providing a keyboard comprising a plurality of key cap, each of the plurality of key caps having a surface, the surfaces of the plurality of key caps being actually on the same plane;
(b) spraying a plurality of ink dots on the surfaces of the plurality of key caps to form a plurality of patterns; and
(c) drying the plurality of patterns on the surface.

14. The key cap pattern printing method of claim 13, further comprising the step of:
forming a print assisting layer on the surface to increase the adhesion between the plurality of ink dots and the surface before step (b).

15. The key cap pattern printing method of claim 13, wherein in step (b), a nozzle is used to spray the plurality of ink dots.

16. The key cap pattern printing method of claim 13, wherein the ink dot is a UV curing ink, an alcohol ink, or an oil-based ink.

17. The key cap pattern printing method of claim 13, wherein in step (c), a UV light or an infrared light is used to irradiate to dry the plurality of patterns, a hot wind is used to dry the plurality of patterns.

18. The key cap pattern printing method of claim 13, wherein the pattern comprises a symbol, a text, a logo, or their combination.

19. The key cap pattern printing method of claim 13, further comprising the step of:
(d) spraying a protection layer to cover the pattern.

20. The key cap pattern printing method of claim 13, wherein the plurality of patterns forms a combination pattern.
